(19) United States
(12) Patent Application Publication
(10) Pub. No.: US 2026/0017528 A1
(43) Pub. Date: Jan. 15, 2026

(54) SYSTEMS AND METHODS FOR TRAINING A LANGUAGE PROCESSING MODEL

(71) Applicant: Capital One Services, LLC, McLean, VA (US)

(72) Inventors: John DAVID, McLean, VA (US); Eric CARLSON, McLean, VA (US)

(73) Assignee: Capital One Services, LLC, McLean, VA (US)

(21) Appl. No.: 18/773,559

(22) Filed: Jul. 15, 2024

(51) Int. Cl. G06N 3/092; G06N 3/048

(52) U.S. Cl. CPC G06N 3/092; G06N 3/048

(57) ABSTRACT

Systems and methods for generating rule sets for machine learning models are described herein. In some aspects, the system receives a first rule set to regulate training of a language processing model. The system trains the language processing model to produce an output text sequence. The system generates a first performance metric for the language processing model as a result of the training. Using a genetic algorithm, the system generates a second rule set based on the first rule set. Using a reinforcement learning algorithm and the second rule set, the system updates parameters of the language processing model. The system iteratively generates a second performance metric for the updated language processing model, uses the reinforcement learning algorithm to generate an updated genetic algorithm, and uses the updated genetic algorithm to further modify the second rule set. The system produces a final language processing model based on the iterative repetition.

### SUMMARY

Methods and systems are described herein for novel uses of and/or improvements to artificial intelligence applications. As one example, methods and systems are described herein for training machine learning models using an adaptable rule set controlled by a genetic algorithm.

Conventionally, machine learning models are trained using guidelines and rule sets that are handcrafted and guided by an engineer's ad hoc choices, sometimes leading to unquantifiable, subjective sources of inefficiency or error. Conventional systems have not contemplated using an algorithm to design rule sets suitable to the particular context of the machine learning model to optimize performance and further update the algorithm in response to performance data of the machine learning model in order to maximize the efficacy of the rule set.

By contrast, methods and systems disclosed herein use a genetic algorithm to tailor a rule set based on fitness scores of activation patterns and logical requirements indicating their effects on the performance of the machine learning model. The system uses a reinforcement learning algorithm to encourage adherence by the language processing model to the rule set while also adjusting the genetic algorithm to provide more suitable rule sets to regulate the language processing model. The symbiotic adaption of the genetic algorithm and the language processing model produces a better fit between the model parameters and the rule set regulating the model, resulting in better training outcomes.

In some aspects, methods and systems are described herein comprising receiving a first rule set to regulate training a language processing model, wherein the first rule set includes one or more activation patterns and wherein the one or more activation patterns are associated with translation of input text sequences into output text sequences by the language processing model; training the language processing model using a training dataset associated with the chatbot and the first rule set to produce an output text sequence, wherein the language processing model is trained with a first loss function that rewards the language processing model for adherence to the first rule set; generating a first performance metric for the language processing model as a result of the training, wherein the first performance metric is based on the first loss function and a second loss function that rewards the language processing model for producing output text sequences in accordance with the training dataset; using a genetic algorithm, generating a second rule set based on the first rule set, wherein the genetic algorithm uses symbolic syntax to evolve an input rule set into an output rule set; using a reinforcement learning algorithm and the second rule set, updating parameters of the language processing model to generate an updated language processing model, wherein the reinforcement learning algorithm evaluates parameters of the language processing model for adherence to the second rule set; generating a second performance metric for the updated language processing model, wherein the second performance metric is based on the first loss function and the second loss function; based on the first performance metric and the second performance metric, using the reinforcement learning algorithm to generate an updated genetic algorithm, wherein the reinforcement learning algorithm evaluates a plurality of configurations of symbolic syntax for the genetic algorithm to optimize the first performance metric and the second performance metric; using the updated genetic algorithm, generating a third rule set based on the second rule set; using the reinforcement learning algorithm and the third rule set to generate a final language processing model based on the updated language processing model; and using the final language processing model to generate a set of text responses to a set of queries.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for training a language processing model using a genetic algorithm to generate rule sets, in accordance with one or more embodiments.

FIG. 2 shows an illustrative block diagram for an iterative process for tuning models, evaluating performance, and regulating genetic algorithms to modify rule sets, in accordance with one or more embodiments.

FIG. 3 shows illustrative components for a system for training a language processing model using a genetic algorithm to generate rule sets, in accordance with one or more embodiments.

FIG. 4 shows a flowchart of the steps involved in training a language processing model using a genetic algorithm to generate rule sets, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

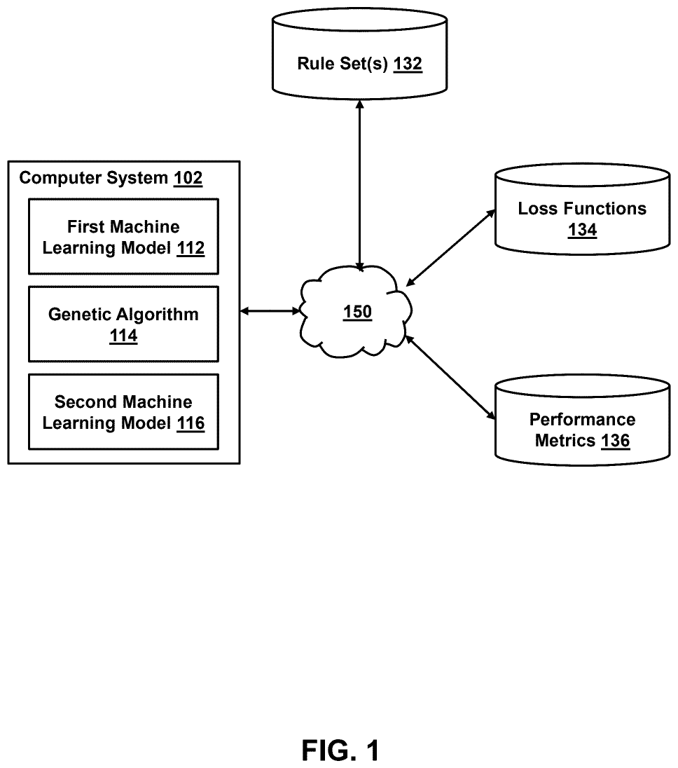

FIG. 1 shows an illustrative diagram for system 150, which contains hardware and software components used to train a machine learning model according to a rule set, use a genetic algorithm to control the rule set, and use a reinforcement learning algorithm to guide the symbiotic adaption between the genetic algorithm, the rule set, and the performance of the machine learning model under the rule set. For example, Computer System 102, a part of system 150, may include First Machine Learning Model 112, Genetic Algorithm 114, and Second Machine Learning Model 116. System 150 may create, store, or otherwise interact with Rule Set(s) 132, Loss Functions 134, and Performance Metrics 136.

System 150 may receive training data containing a first set of features, which may be used as input by a machine learning model (e.g., First Machine Learning Model 112). The training data may be text sequences used to train a language processing model to produce corresponding output text sequences. For example, First Machine Learning Model 112 may be deployed to a chatbot designed to provide conversational responses to user queries. The training data may, for example, be a collection of past user queries. Each user query may correspond to a standard response, also included in the training data. The standard response may be indicative of an answer that First Machine Learning Model 112 should produce upon completion of training.

First Machine Learning Model 112 may use an algorithm to translate a set of input features into an output. First Machine Learning Model 112 may take as input a vector representing text tokens in a user query and output a text sequence representing an answer to the user query. First Machine Learning Model 112 may use one or more algorithms like transformer-based algorithms, artificial neural networks, or deep neural networks to perform language processing and generate output text sequences. The system may regulate First Machine Learning Model 112 according to a first rule set (e.g., Rule Set(s) 132). The rule set may contain activation patterns describing operations of First Machine Learning Model 112. For example, Rule Set(s) 132 may contain a chain-of-thought prompting technique for activating a language processing model. In another example, Rule Set(s) 132 may contain a relationship between input text sequences and output text sequences for the language processing model. Rule Set(s) 132 may include example input sequences and descriptions of corresponding output sequences expected of First Machine Learning Model 112. For example, Rule Set(s) 132 may require an algorithm for particular types of input sequences and a different algorithm for other input sequences. In another example, Rule Set(s) 132 includes an activation pattern comprising a maximum depth, a maximum breadth, and an activation function for a deep neural network in the language processing model. The logical rules in Rule Set(s) 132 may operate independently or in conjunction. For example, a rule regulating the algorithm of First Machine Learning Model 112 may be used in addition to a rule in Rule Set(s) 132 describing security requirements that the output must meet. However, an activation pattern for a first algorithm and a pattern for a second algorithm may be used only where the conditions apply. Rule Set(s) 132 may use symbolic syntax to relate one or more activation patterns in logical succession.

The system may partition the training data into a training set and a cross-validating set. Using the training set, the system may train First Machine Learning Model 112 using, for example, the gradient descent technique. The system may then cross-validate the trained model using the cross-validating set and further fine-tune the parameters of the model. First Machine Learning Model 112 may include one or more parameters that it uses to translate input into outputs. For example, an artificial neural network contains a matrix of weights in which each weight is a real number. The repeated multiplication and combination of weights transform input values to First Machine Learning Model 112 into output values. The system may measure the performance of First Machine Learning Model 112 using a method such as cross-validation to generate a quantitative representation—e.g., a first accuracy metric.

The system may measure success in the training of First Machine Learning Model 112 using loss functions and performance metrics. For example, Loss Functions 134 may include an accuracy loss function and a fidelity loss function. The accuracy loss function describes how closely the output text sequences resemble the standard output text sequences in the training data. The system intends First Machine Learning Model 112 to produce output sequences similar to those in the training data, and the accuracy loss function is used to encourage similarity from its output to standard outputs by capturing a degree of overlap between text sequences. In some embodiments, the system may use a similarity machine learning model as a loss function. The similarity machine learning model may output a numerical score by processing two input text sequences, the numerical score representing the degree of similarity between the contents of the input text sequences. The fidelity loss function captures First Machine Learning Model 112's adherence to the first rule set. For example, the fidelity loss function may measure the number of logical requirements in Rule Set(s) 132 not met by First Machine Learning Model 112 when tested for its training epoch. For example, each activation pattern not satisfied by First Machine Learning Model 112 when tested may result in one point lost in the fidelity loss function.

Using Loss Functions 134, the system may generate a performance metric in Performance Metrics 136. The system may retrieve a set of runtime activation patterns, an input sequence set, and an output sequence set. The system may compare the set of runtime activation patterns against the first rule set to generate an adherence score indicating the degree to which Rule Set(s) 132 was met. The system may additionally or alternatively generate a correctness score, also referred to as an error rate, by comparing the input sequence set and the output sequence set against a benchmark output sequence in the training dataset. In some embodiments, the system may generate a mathematical combination of a numerical adherence score and an error rate to be a performance metric corresponding to a training epoch of First Machine Learning Model 112. For example, the performance metric may be based on a weighted average of the numerical values for loss functions. The system may compute an inverse of the error rate calculated by the accuracy loss function and add to it the inverse of the number of activation patterns not met by First Machine Learning Model 112. Alternatively, the system may compute the performance metric based on the lesser of a numerical score for the fidelity loss function and the numerical score for the accuracy loss function. The system may record Performance Metrics 136, for example, in order to gauge how well the first rule set in Rule Set(s) 132 matches First Machine Learning Model 112. Performance Metrics 136 may be used to update Genetic Algorithm 114, for example, to produce rule sets more suitable to machine learning models.

Using Genetic Algorithm 114, the system may generate a second rule set based on a first rule set in Rule Set(s) 132. For example, the first rule set may be one or more logical requirements or activation patterns currently contained in Rule Set(s) 132. For example, the system may do so by modifying one or more rules in the first rule set. The system may additionally or alternatively add rules to the second rule set or remove rules in the first rule set entirely. The system may identify fitness scores corresponding to one or more activation patterns or logical requirements. The fitness scores may indicate the degree of alignment or misalignment between an activation pattern or logical requirement and First Machine Learning Model 112. In some embodiments, Genetic Algorithm 114 may use an evaluative function to assign fitness scores to activation patterns and logical requirements in Rule Set(s) 132 based on desired rules regulating First Machine Learning Model 112. Genetic Algorithm 114 may, with reference to the fitness scores, generate new rules for Rule Set(s) 132 or modify existing rules in an evolutionary or adaptive manner. For example, Genetic Algorithm 114 may use crossover and recombination to rearrange the parameters of an activation pattern to more closely resemble the average of other activation patterns. Additionally, or alternatively, Genetic Algorithm 114 may use mutation operations to cause random changes to activation patterns in Rule Set(s) 132. For example, an activation pattern specifying the activation threshold of neurons in a neural network may randomly adjust the activation threshold by a numerical amount. Genetic Algorithm 114 may, for example, control the crossover and mutation operations on Rule Set(s) 132 using the fitness scores. An activation pattern with a higher fitness score is likelier to be used in crossover to inform other activation patterns and less likely to require a mutation. On the other hand, activation patterns with lower fitness scores are likelier to mutate and likelier to be replaced by crossovers of other activation patterns. Genetic Algorithm 114 may use combinatorics on activation patterns in Rule Set(s) 132 in an analogous manner to selecting individuals from the current population to be parents and using them to produce the children for the next generation. In some embodiments, Genetic Algorithm 114 may iteratively perform crossover and mutation to Rule Set(s) 132 until a set number of generations have elapsed or until all members of Rule Set(s) 132 satisfy a threshold regarding fitness scores.

Using a reinforcement learning algorithm and the second rule set, the system may update parameters of First Machine Learning Model 112 to generate an updated machine learning model (e.g., Second Machine Learning Model 116). For example, the reinforcement learning algorithm may correlate Loss Functions 134 with parameters of First Machine Learning Model 112. For example, using a gradient descent technique, the system may determine weights and biases that contributed to poor performance as determined by the loss functions. For example, in a neural network, weights and biases may be correlated with prediction errors. Each weight and bias may be increased or decreased in proportion to their effect on the predictive accuracy of the model. The system may use, for example, a backpropagation method to calculate the effects of each parameter of the model in contributing to poor performance regarding Loss Functions 134. The system may adjust Second Machine Learning Model 116 to also increase its adherence to Rule Set(s) 132. For example, the system may change the algorithm of Second Machine Learning Model 116 to achieve an activation pattern specified by Rule Set(s) 132. In another example, the system may modify the number of layers in a neural network to increase the probability of meeting a requirement for depth or accuracy in Rule Set(s) 132. In some embodiments, the system may update the training process of Second Machine Learning Model 116 based on the reinforcement learning algorithm. For example, the system may update hyperparameters controlling the number of training epochs for Second Machine Learning Model 116, the learning rate at which the parameters are changed, or training data batch size.

The system may generate a second performance metric in Performance Metrics 136, corresponding to Second Machine Learning Model 116. For example, the system may, after training Second Machine Learning Model 116 based on First Machine Learning Model 112, retrieve a set of runtime activation patterns, an input sequence set, and an output sequence set. The system may compare the set of runtime activation patterns against the first rule set to generate an adherence score indicating the degree to which Rule Set(s) 132 was met. The system may additionally or alternatively generate a correctness score by comparing the input sequence set and the output sequence set against a benchmark output sequence in the training dataset. The system may then use a mathematical combination of the adherence score and the correctness score to generate the performance metric. The system may compute the performance metric of Second Machine Learning Model 116 in Performance Metrics 136 using the same methods as those used for First Machine Learning Model 112.

Based on the first performance metric and the second performance metric, the system may use the reinforcement learning algorithm to update the genetic algorithm. For example, the reinforcement learning algorithm may modify the evaluation function of Genetic Algorithm 114, the crossover likelihood based on fitness scores, and the mutation probabilities. For example, the reinforcement learning algorithm may cause Genetic Algorithm 114 to change its evaluation function to assign fitness scores to different activation patterns based on the performance metrics in Performance Metric 136 considered by the reinforcement learning algorithm. For example, activation patterns that cause greater adherence performance metrics may be considered superior by the reinforcement learning algorithm. The reinforcement learning algorithm may change the evaluative function in Genetic Algorithm 114, which assigns fitness scores to activation patterns such that activation patterns correlated with better adherence performance metrics are assigned higher fitness scores. Additionally, or alternatively, the reinforcement learning algorithm may modify the crossover mechanisms of Genetic Algorithm 114. For example, the reinforcement learning algorithm may change the assimilation rate of Genetic Algorithm 114 upon crossover. Whereas before an activation pattern retains 20% of its original parameters to absorb 80% of the parameters of a new activation pattern, the reinforcement learning algorithm may modify the absorption rate such that the activation pattern now retains 30% of its parameters upon crossover. The reinforcement learning algorithm may also modify the mutation probabilities of Genetic Algorithm 114. For example, the chances of random modifications to activation patterns in Rule Set(s) 132 may be adjusted based on Performance Metrics 136.

The system may repeat the process of training the machine learning model, updating the rule set, and then using the performance of the machine learning model to update the genetic algorithm. The system may use the repetition of the process to both tailor a set of rules suitable to the machine learning model and to ensure high performance of the machine learning model regarding both adherence to the rule set and accuracy in prediction. For example, the system may generate further changes to Rule Set(s) 132 after updating Genetic Algorithm 114 using the reinforcement learning algorithm and Performance Metrics 136. For example, the system may generate a third rule set in Rule Set(s) 132. Using the third rule set and the reinforcement learning algorithm, the system may further update Second Machine Learning Model 116 (e.g., based on the training data) to generate a finalized machine learning model. The system may keep using the reinforcement learning algorithm to update the genetic algorithm, update rule sets, and retrain the machine learning model until the model performs sufficiently well on a performance metric. The model may then be deployed to generate a set of text responses to a set of queries.

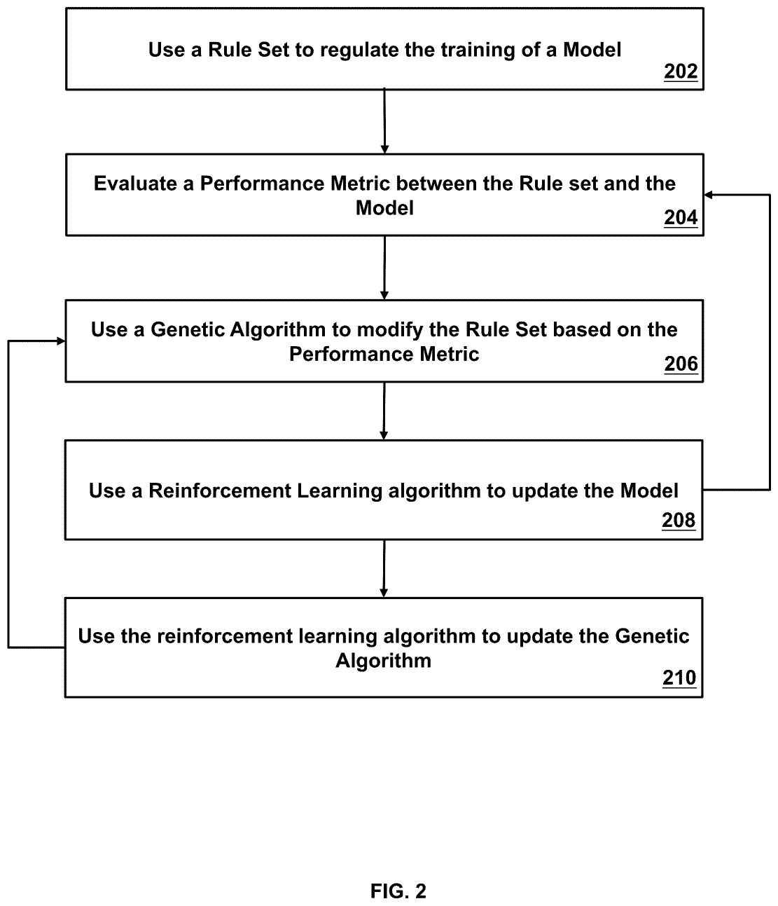

FIG. 2 shows a simple operational diagram showing how a reinforcement algorithm is used to control a genetic algorithm that adapts rule sets regulating the training of a machine learning model.

In Process 202, the system may train a machine learning model using a first rule set. The rule set may contain activation patterns describing the operations of the machine learning model. For example, the rule set may contain a chain-of-thought prompting technique for activating a language processing model. The rule set may specify a relationship between input text sequences and output text sequences for the machine learning model. The rule set may contain quantitative parameters such as a maximum depth, a maximum breadth, a regularization function designed to correct the overfitting of the machine learning model, and a linear programming constraint. The machine learning model is to adhere to the rule set in its training and testing, and the adherence can be quantitatively measured as a performance metric.

In Process 204, the system may evaluate a performance metric based on the machine learning model and the rule set. The system may retrieve a set of runtime activation patterns, an input sequence set, and an output sequence set. The system may compare the set of runtime activation patterns against the first rule set to generate an adherence score indicating the degree to which Rule Set(s) 132 was met. The system may additionally or alternatively generate a correctness score, also referred to as an error rate, by comparing the input sequence set and the output sequence set against a benchmark output sequence in the training dataset. In some embodiments, the system may generate a mathematical combination of a numerical adherence score and an error rate to be a performance metric corresponding to a training epoch of First Machine Learning Model 112. For example, the performance metric may be based on a weighted average of the numerical values for loss functions. The system may compute an inverse of the error rate calculated by the accuracy loss function and add to it the inverse of the number of activation patterns not met by First Machine Learning Model 112. Alternatively, the system may compute the performance metric based on the lesser of a numerical score for the fidelity loss function and the numerical score for the accuracy loss function. The performance metric may serve two purposes: to measure how well the machine learning model performs under the rule set and to indicate the extent to which the rule set fits the operations of the machine learning model.

Based on the performance metric, the system may use a genetic algorithm to generate a second rule set from the first rule set in Process 206. The process used by the genetic algorithm modifies one or more rules in the first rule set. The system may additionally or alternatively add rules to the second rule set or remove rules in the first rule set entirely. The system may identify fitness scores corresponding to one or more activation patterns or logical requirements. The fitness scores may indicate the degree of alignment or misalignment between an activation pattern or logical requirement and the machine learning model in testing. In some embodiments, the genetic algorithm may use an evaluative function to assign fitness scores to activation patterns and logical requirements in the rule set based on desired rules regulating the machine learning model. The genetic algorithm may, with reference to the fitness scores, generate new rules for the rule set or modify existing rules in an evolutionary or adaptive manner.

In Process 208, the system may update the machine learning model using reinforcement learning, for example, by correlating the performance metric with parameters of the machine learning model. For example, using a gradient descent technique, the system may determine weights and biases that contributed to poor performance as determined by the loss functions. For example, in a neural network, weights and biases may be correlated with prediction errors. Each weight and bias may be increased or decreased in proportion to their effect on the predictive accuracy of the model. The system may use, for example, a backpropagation method to calculate the effects of each parameter of the model in contributing to poor performance and adjust the parameters of the machine learning model accordingly. The system may also change the architecture of the machine learning model's training or performance, for example, by modifying the number of layers in a neural network to increase the probability of meeting a requirement for depth or accuracy or updating hyperparameters controlling the number of training epochs. After Process 208 modifies the machine learning model, the system may re-evaluate a performance metric of the updated machine learning model based on Process 204. The re-evaluation is to examine how suitable the rule set is for the machine learning model after the machine learning model has been adapted to the rule set, and therefore the new performance metric may indicate the defects or mismatches in the rule set and may point to areas of potential improvement for the rule set. If the re-evaluated performance metric is below a certain threshold, the system may enact Process 210 to modify the genetic algorithm. Otherwise, the system may reactivate Process 204 following Process 208.

With the updated machine learning model and the re-evaluated performance metric, the system may once again use the genetic algorithm to evolve the rule set in the same process as Process 206. The updated rule set may cause the system to again update the machine learning model in Process 208 and cause an iterative process leading back to Process 204. The system may choose to halt the iterative process and generate a final language processing model when the performance metric numerically converges or hits a threshold. Concurrently, the system may use the re-evaluated performance metric to modify the genetic algorithm in a process described below.

Based on the updated machine learning model and its performance metric, the system may modify the genetic algorithm in Process 210. For example, the reinforcement learning algorithm may modify the evaluation function of the genetic algorithm, the crossover likelihood based on fitness scores, and the mutation probabilities. For example, the reinforcement learning algorithm may cause the genetic algorithm to change its evaluation function to assign fitness scores to different activation patterns based on the performance metrics considered by the reinforcement learning algorithm. For example, activation patterns that cause greater adherence performance metrics may be considered superior by the reinforcement learning algorithm. The reinforcement learning algorithm may change the evaluative function in the genetic algorithm, which assigns fitness scores to activation patterns such that activation patterns correlated with better adherence performance metrics are assigned higher fitness scores. Additionally, or alternatively, the reinforcement learning algorithm may modify the crossover mechanisms of the genetic algorithm. For example, the reinforcement learning algorithm may change the assimilation rate of the genetic algorithm upon crossover.

With the updated genetic algorithm, the system may further adapt the rule set and cause the iterative repetition of steps, including re-evaluating the currently updated machine learning model, using the performance metric to update the machine learning model further, and modifying the genetic algorithm. For example, the system may perform Process 206 following Process 210 in response to a performance metric being below a certain threshold, after which Process 208 and Process 210 may follow, creating an iterative repetition. The process may repeat until the system detects a measure of convergence, which is when the performance metric makes no significant improvements after a number of repetitions. Alternatively, the system may halt the repetition after Process 208, skipping over Process 210 in response to a high-performance metric of the machine learning model.

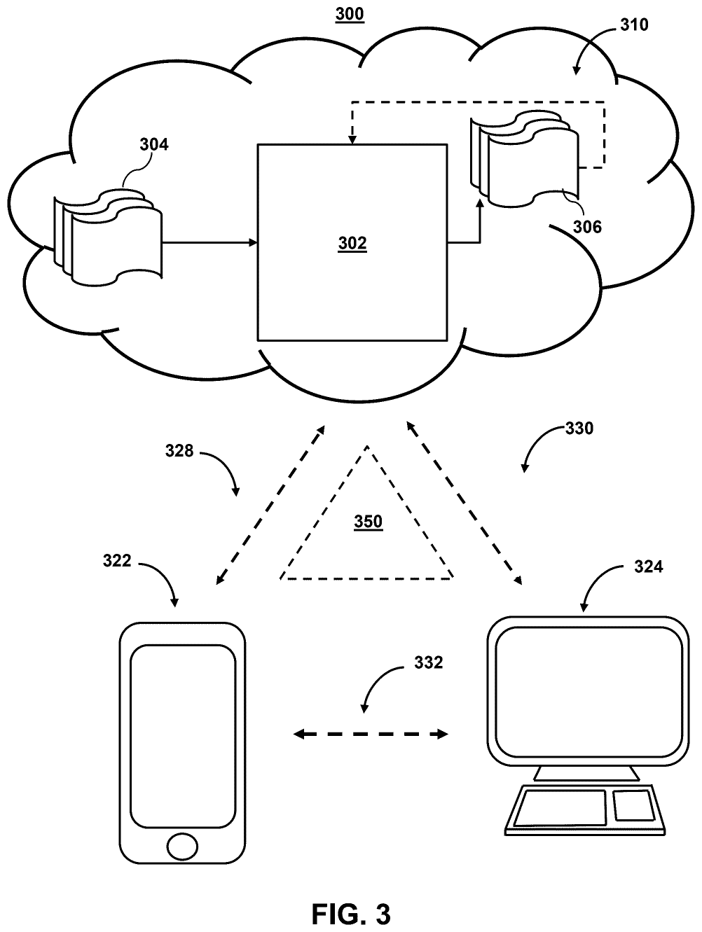

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational responses, queries, and/or notifications).

Additionally, as mobile device 322 and user terminal 324 are shown as a touchscreen smartphone and personal computer, respectively, these displays also act as user input interfaces. It should be noted that in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302, where forward stimulation is used to reset weights on the “front” neural units. In some embodiments, stimulation and inhibition for model 302 may be more free flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions.

System 300 also includes API layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer, where microservices reside. In this kind of architecture, the role of the API layer 350 may provide integration between front end and back end layers. In such cases, API layer 350 may use RESTful APIs (exposition to front end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API platforms and their modules. API layer 350 may use a developer portal. API layer 350 may use strong security constraints applying WAF and DDOS protection, and API layer 350 may use RESTful APIs as standard for external integration.

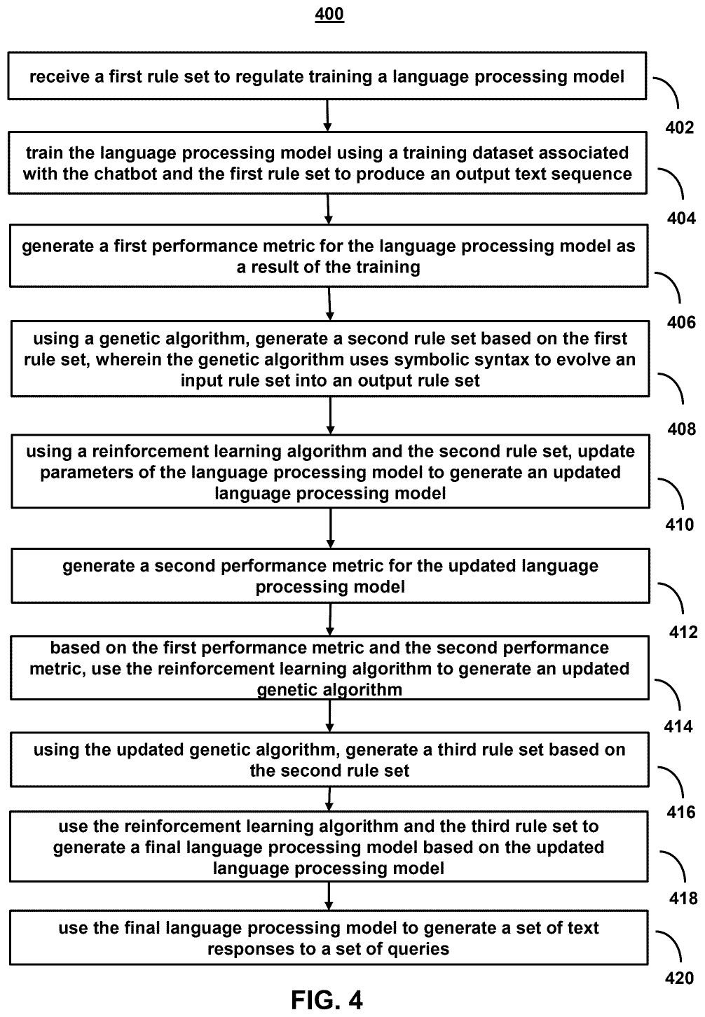

FIG. 4 shows a flowchart of the steps involved in training a language processing model using a genetic algorithm to generate rule sets, in accordance with one or more embodiments. For example, the system may use process 400 (e.g., as implemented on one or more system components described above) in order to train machine learning models according to rule sets, generate performance metrics assessing the degree of fit between a machine learning model and its rule set, adapting rule sets using genetic algorithms, and using a reinforcement learning algorithm to regulate both the genetic algorithm and the machine learning models.

At step 402, process 400 (e.g., using one or more components described above) may receive a first rule set to regulate training a language processing model. First Machine Learning Model 112 may use an algorithm to translate a set of input features into an output. The system may regulate First Machine Learning Model 112 according to a first rule set (e.g., Rule Set(s) 132). The rule set may contain activation patterns describing operations of First Machine Learning Model 112. For example, Rule Set(s) 132 may contain a chain-of-thought prompting technique for activating a language processing model. In another example, Rule Set(s) 132 may contain a relationship between input text sequences and output text sequences for the language processing model. Rule Set(s) 132 may include example input sequences and descriptions on corresponding output sequences expected of First Machine Learning Model 112. For example, Rule Set(s) 132 may require an algorithm for particular types of input sequences and a different algorithm for other input sequences. In another example, Rule Set(s) 132 includes an activation pattern comprising a maximum depth, a maximum breadth, and an activation function for a deep neural network in the language processing model. The logical rules in Rule Set(s) 132 may operate independently or in conjunction. For example, a rule regulating the algorithm of First Machine Learning Model 112 may be used in addition to a rule in Rule Set(s) 132 describing security requirements that the output must meet. However, an activation pattern for a first algorithm and a pattern for a second algorithm may be used only where the conditions apply. Rule Set(s) 132 may use symbolic syntax to relate one or more activation patterns in logical succession.

At step 404, process 400 (e.g., using one or more components described above) may train the language processing model using a training dataset associated with the chatbot and the first rule set to produce an output text sequence. First Machine Learning Model 112 may take as input a vector representing text tokens in a user query and output a text sequence representing an answer to the user query. First Machine Learning Model 112 may use one or more algorithms like transformer-based algorithms, artificial neural networks, or deep neural networks to perform language processing and generate output text sequences. The system may partition the training data into a training set and a cross-validating set. Using the training set, the system may train First Machine Learning Model 112 using, for example, the gradient descent technique. The system may then cross-validate the trained model using the cross-validating set and further fine-tune the parameters of the model. First Machine Learning Model 112 may include one or more parameters that it uses to translate input into outputs. For example, an artificial neural network contains a matrix of weights in which each weight is a real number. The repeated multiplication and combination of weights transform input values to First Machine Learning Model 112 into output values. The system may measure the performance of First Machine Learning Model 112 using a method such as cross-validation to generate a quantitative representation—e.g., a first accuracy metric.

At step 406, process 400 (e.g., using one or more components described above) may generate a first performance metric for the language processing model as a result of the training. The system may measure success in the training of First Machine Learning Model 112 using loss functions and performance metrics. For example, Loss Functions 134 may include an accuracy loss function and a fidelity loss function. The accuracy loss function describes how closely the output text sequences resemble the standard output text sequences in the training data. The system intends First Machine Learning Model 112 to produce output sequences similar to those in the training data, and the accuracy loss function is used to encourage similarity from its output to standard outputs by capturing a degree of overlap between text sequences. In some embodiments, the system may use a similarity machine learning model as a loss function. The similarity machine learning model may output a numerical score by processing two input text sequences, the numerical score representing the degree of similarity between the contents of the input text sequences.

Using Loss Functions 134, the system may generate a performance metric in Performance Metrics 136. The system may retrieve a set of runtime activation patterns, an input sequence set, and an output sequence set. The system may compare the set of runtime activation patterns against the first rule set to generate an adherence score indicating the degree to which Rule Set(s) 132 was met. The system may additionally or alternatively generate a correctness score, also referred to as an error rate, by comparing the input sequence set and the output sequence set against a benchmark output sequence in the training dataset. In some embodiments, the system may generate a mathematical combination of a numerical adherence score and an error rate to be a performance metric corresponding to a training epoch of First Machine Learning Model 112. For example, the performance metric may be based on a weighted average of the numerical values for loss functions. The system may compute an inverse of the error rate calculated by the accuracy loss function and add to it the inverse of the number of activation patterns not met by First Machine Learning Model 112. Alternatively, the system may compute the performance metric based on the lesser of a numerical score for the fidelity loss function and the numerical score for the accuracy loss function. The system may record Performance Metrics 136, for example, in order to gauge how well the first rule set in Rule Set(s) 132 matches First Machine Learning Model 112. Performance Metrics 136 may be used to update Genetic Algorithm 114, for example, to produce rule sets more suitable to machine learning models.

At step 408, process 400 (e.g., using one or more components described above) may, using a genetic algorithm, generate a second rule set based on the first rule set, wherein the genetic algorithm uses symbolic syntax to evolve an input rule set into an output rule set. Using Genetic Algorithm 114, the system may generate a second rule set based on a first rule set in Rule Set(s) 132. For example, the first rule set may be one or more logical requirements or activation patterns currently contained in Rule Set(s) 132. For example, the system may do so by modifying one or more rules in the first rule set. The system may additionally or alternatively add rules to the second rule set or remove rules in the first rule set entirely. The system may identify fitness scores corresponding to one or more activation patterns or logical requirements. The fitness scores may indicate the degree of alignment or misalignment between an activation pattern or logical requirement and First Machine Learning Model 112. In some embodiments, Genetic Algorithm 114 may use an evaluative function to assign fitness scores to activation patterns and logical requirements in Rule Set(s) 132 based on desired rules regulating First Machine Learning Model 112. Genetic Algorithm 114 may, with reference to the fitness scores, generate new rules for Rule Set(s) 132 or modify existing rules in an evolutionary or adaptive manner. For example, Genetic Algorithm 114 may use crossover and recombination to rearrange the parameters of an activation pattern to more closely resemble the average of other activation patterns. Additionally, or alternatively, Genetic Algorithm 114 may use mutation operations to cause random changes to activation patterns in Rule Set(s) 132. For example, an activation pattern specifying the activation threshold of neurons in a neural network may randomly adjust the activation threshold by a numerical amount. Genetic Algorithm 114 may, for example, control the crossover and mutation operations on Rule Set(s) 132 using the fitness scores. An activation pattern with a higher fitness score is likelier to be used in crossover to inform other activation patterns and less likely to require a mutation. On the other hand, activation patterns with lower fitness scores are likelier to mutate and likelier to be replaced by crossovers of other activation patterns. Genetic Algorithm 114 may use combinatorics on activation patterns in Rule Set(s) 132 in an analogous manner to selecting individuals from the current population to be parents and using them to produce the children for the next generation. In some embodiments, Genetic Algorithm 114 may iteratively perform crossover and mutation to Rule Set(s) 132 until a set number of generations have elapsed or until all members of Rule Set(s) 132 satisfy a threshold regarding fitness scores.

At step 410, process 400 (e.g., using one or more components described above) may, using a reinforcement learning algorithm and the second rule set, update parameters of the language processing model to generate an updated language processing model. Using a reinforcement learning algorithm and the second rule set, the system may update parameters of First Machine Learning Model 112 to generate an updated machine learning model (e.g., Second Machine Learning Model 116). For example, the reinforcement learning algorithm may correlate Loss Functions 134 with parameters of First Machine Learning Model 112. For example, using a gradient descent technique, the system may determine weights and biases that contributed to poor performance as determined by the loss functions. For example, in a neural network, weights and biases may be correlated with prediction errors. Each weight and bias may be increased or decreased in proportion to their effect on the predictive accuracy of the model. The system may use, for example, a backpropagation method to calculate the effects of each parameter of the model in contributing to poor performance regarding Loss Functions 134. The system may adjust Second Machine Learning Model 116 to also increase its adherence to Rule Set(s) 132. For example, the system may change the algorithm of Second Machine Learning Model 116 to achieve an activation pattern specified by Rule Set(s) 132. In another example, the system may modify the number of layers in a neural network to increase the probability of meeting a requirement for depth or accuracy in Rule Set(s) 132. In some embodiments, the system may update the training process of Second Machine Learning Model 116 based on the reinforcement learning algorithm. For example, the system may update hyperparameters controlling the number of training epochs for Second Machine Learning Model 116, the learning rate at which the parameters are changed, or training data batch size.

At step 412, process 400 (e.g., using one or more components described above) may generate a second performance metric for the updated language processing model. The system may generate a second performance metric in Performance Metrics 136, corresponding to Second Machine Learning Model 116. For example, the system may, after training Second Machine Learning Model 116 based on First Machine Learning Model 112, retrieve a set of runtime activation patterns, an input sequence set, and an output sequence set. The system may compare the set of runtime activation patterns against the first rule set to generate an adherence score indicating the degree to which Rule Set(s) 132 was met. The system may additionally or alternatively generate a correctness score by comparing the input sequence set and the output sequence set against a benchmark output sequence in the training dataset. The system may then use a mathematical combination of the adherence score and the correctness score to generate the performance metric. The system may compute the performance metric of Second Machine Learning Model 116 in Performance Metrics 136 using the same methods as those used for First Machine Learning Model 112.

At step 414, process 400 (e.g., using one or more components described above) may, based on the first performance metric and the second performance metric, use the reinforcement learning algorithm to generate an updated genetic algorithm. Based on the first performance metric and the second performance metric, the system may use the reinforcement learning algorithm to update the genetic algorithm. For example, the reinforcement learning algorithm may modify the evaluation function of Genetic Algorithm 114, the crossover likelihood based on fitness scores, and the mutation probabilities. For example, the reinforcement learning algorithm may cause Genetic Algorithm 114 to change its evaluation function to assign fitness scores to different activation patterns based on the performance metrics in Performance Metric 136 considered by the reinforcement learning algorithm. For example, activation patterns that cause greater adherence performance metrics may be considered superior by the reinforcement learning algorithm. The reinforcement learning algorithm may change the evaluative function in Genetic Algorithm 114, which assigns fitness scores to activation patterns such that activation patterns correlated with better adherence performance metrics are assigned higher fitness scores. Additionally, or alternatively, the reinforcement learning algorithm may modify the crossover mechanisms of Genetic Algorithm 114. For example, the reinforcement learning algorithm may change the assimilation rate of Genetic Algorithm 114 upon crossover. Whereas before an activation pattern retains 20% of its original parameters to absorb 80% of the parameters of a new activation pattern, the reinforcement learning algorithm may modify the absorption rate such that the activation pattern now retains 30% of its parameters upon crossover. The reinforcement learning algorithm may also modify the mutation probabilities of Genetic Algorithm 114. For example, the chances of random modifications to activation patterns in Rule Set(s) 132 may be adjusted based on Performance Metrics 136.

At step 416, process 400 (e.g., using one or more components described above) may, using the updated genetic algorithm, generate a third rule set based on the second rule set. The system may repeat the process of training the machine learning model, updating the rule set, and then using the performance of the machine learning model to update the genetic algorithm. The system may use the repetition of the process to both tailor a set of rules suitable to the machine learning model and to ensure high performance of the machine learning model regarding both adherence to the rule set and accuracy in prediction. For example, the system may generate further changes to Rule Set(s) 132 after updating Genetic Algorithm 114 using the reinforcement learning algorithm and Performance Metrics 136. For example, the system may generate a third rule set in Rule Set(s) 132. Using the third rule set and the reinforcement learning algorithm, the system may further update Second Machine Learning Model 116 (e.g., based on the training data) to generate a finalized machine learning model. The system may keep using the reinforcement learning algorithm to update the genetic algorithm, update rule sets, and retrain the machine learning model until the model performs sufficiently well on a performance metric. The model may then be deployed to generate a set of text responses to a set of queries.

At step 418, process 400 (e.g., using one or more components described above) may use the reinforcement learning algorithm and the third rule set to generate a final language processing model based on the updated language processing model. The process is analogous to updating the parameters of the language processing model in step 410. The system may cause the iterative repetition of steps, including re-evaluating the currently updated machine learning model, using the performance metric to update the machine learning model further, and modifying the genetic algorithm. The process may repeat until the system detects a measure of convergence, which is when the performance metric makes no significant improvements after a number of repetitions. Alternatively, the system may choose to halt the iterative repetition to generate a final language processing model in response to the performance metric being above a numerical threshold in a repetition.

At step 420, process 400 (e.g., using one or more components described above) may use the final language processing model to generate a set of text responses to a set of queries. The final language processing model may be deployed to a conversational program and, for example, provide informational responses to user queries. The final language processing model may be expected to adhere to the final rule set with a high degree of accuracy to provide the user with relevant and precise responses to their requests.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for training a language processing model for a chatbot, comprising: receiving a first rule set to regulate training a language processing model, wherein the first rule set includes one or more activation patterns, and wherein the one or more activation patterns are associated with translation of input text sequences into output text sequences by the language processing model; training the language processing model using a training dataset associated with the chatbot and the first rule set to produce an output text sequence, wherein the language processing model is trained with a first loss function that rewards the language processing model for adherence to the first rule set; generating a first performance metric for the language processing model as a result of the training, wherein the first performance metric is based on the first loss function and a second loss function that rewards the language processing model for producing output text sequences in accordance with the training dataset; iteratively repeating: using a genetic algorithm, generating a second rule set based on the first rule set, wherein the genetic algorithm uses symbolic syntax to evolve an input rule set into an output rule set; using a reinforcement learning algorithm and the second rule set, updating parameters of the language processing model to generate an updated language processing model, wherein the reinforcement learning algorithm evaluates parameters of the language processing model for adherence to the second rule set; generating a second performance metric for the updated language processing model, wherein the second performance metric is based on the first loss function and the second loss function; based on the first performance metric and the second performance metric, using the reinforcement learning algorithm to update the genetic algorithm, wherein the reinforcement learning algorithm evaluates a plurality of configurations of symbolic syntax for the genetic algorithm to optimize the first performance metric and the second performance metric; and based on the second performance metric exceeding a threshold value, determining to stop the iterative repetition; and using the updated language processing model to generate a set of text responses to a set of queries.
2. A method for training a language processing model for a chatbot, comprising: receiving a first rule set to regulate training a language processing model, wherein the first rule set includes one or more activation patterns, and wherein the one or more activation patterns are associated with translation of input text sequences into output text sequences by the language processing model; training the language processing model using a training dataset associated with the chatbot and the first rule set to produce an output text sequence, wherein the language processing model is trained with a first loss function that rewards the language processing model for adherence to the first rule set; generating a first performance metric for the language processing model as a result of the training, wherein the first performance metric is based on the first loss function and a second loss function that rewards the language processing model for producing output text sequences in accordance with the training dataset; using a genetic algorithm, generating a second rule set based on the first rule set, wherein the genetic algorithm uses symbolic syntax to evolve an input rule set into an output rule set; using a reinforcement learning algorithm and the second rule set, updating parameters of the language processing model to generate an updated language processing model, wherein the reinforcement learning algorithm evaluates parameters of the language processing model for adherence to the second rule set; generating a second performance metric for the updated language processing model, wherein the second performance metric is based on the first loss function and the second loss function; based on the first performance metric and the second performance metric, using the reinforcement learning algorithm to generate an updated genetic algorithm, wherein the reinforcement learning algorithm evaluates a plurality of configurations of symbolic syntax for the genetic algorithm to optimize the first performance metric and the second performance metric; using the updated genetic algorithm, generating a third rule set based on the second rule set; using the reinforcement learning algorithm and the third rule set to generate a final language processing model based on the updated language processing model; and using the final language processing model to generate a set of text responses to a set of queries.
3. A method for training a language processing model for a chatbot, comprising: receiving a language processing model and a first rule set to regulate the language processing model, wherein the first rule set includes one or more activation patterns, and wherein the one or more activation patterns are associated with translation of input text sequences into output text sequences by the language processing model; generating a first performance metric for the language processing model based on a first loss function that rewards the language processing model for adherence to the first rule set; using a genetic algorithm, generating a second rule set based on the first rule set, wherein the genetic algorithm uses symbolic syntax to evolve an input rule set into an output rule set; using a reinforcement learning algorithm and the second rule set, updating parameters of the language processing model to generate an updated language processing model, wherein the reinforcement learning algorithm evaluates parameters of the language processing model for adherence to the second rule set; generating a second performance metric for the updated language processing model, wherein the second performance metric is based on the first loss function and the second loss function; based on the first performance metric and the second performance metric, using the reinforcement learning algorithm to generate an updated genetic algorithm, wherein the reinforcement learning algorithm evaluates a plurality of configurations of symbolic syntax for the genetic algorithm to optimize the first performance metric and the second performance metric; using the updated genetic algorithm, generating a third rule set based on the second rule set; using a reinforcement learning algorithm and the third rule set to generate a final language processing model based on the updated language processing model; and using the final language processing model to generate a set of text responses to a set of queries.
4. The method of any one of the preceding embodiments, wherein the first rule set comprises an activation pattern comprising a relationship between input text sequences and output text sequences for the language processing model.
5. The method of any one of the preceding embodiments, wherein the first rule set comprises an activation pattern comprising a maximum depth, a maximum breadth, and an activation function for a deep neural network in the language processing model.
6. The method of any one of the preceding embodiments, wherein the first rule set uses symbolic syntax to relate one or more activation patterns in logical succession.
7. The method of any one of the preceding embodiments, wherein generating the second rule set using the genetic algorithm comprises: using an evaluative function of the genetic algorithm, generating a fitness metric based on the first performance metric, wherein the fitness metric is a real-valued vector symbolizing a suitability of the first rule set for the language processing model; generating a candidate rule set from the first rule set, wherein the candidate rule set comprises one or more activation patterns in the first rule set with values in the fitness metric above a threshold value; and performing mathematical permutations on the candidate rule set to generate the second rule set, wherein the mathematical permutations modify values specifying activation patterns in the candidate rule set.
8. The method of any one of the preceding embodiments, wherein generating the first performance metric for the language processing model as a result of the training comprises: after training the language processing model, retrieving a set of runtime activation patterns, an input sequence set, and an output sequence set; comparing the set of runtime activation patterns against the first rule set to generate an adherence score; comparing the input sequence set and the output sequence set against a benchmark dataset to generate a correctness score, wherein the training dataset specifies example output sequence sets for each input sequence set; and generating the first performance metric based on the adherence score and the correctness score.
9. The method of any one of the preceding embodiments, wherein using a reinforcement learning regimen and the second rule set to update parameters of the language processing model comprises: generating a second performance metric for the language processing model based on the second rule set; using a gradient descent technique, generating a corrective vector based on the second performance metric, the corrective vector specifying numeric changes to parameter values of the language processing model; and based on the corrective vector, updating parameter values of the language processing model.
10. The method of any one of the preceding embodiments, wherein using the reinforcement learning algorithm to update the genetic algorithm based on the first performance metric and the second performance metric comprises: based on the language processing model, the first performance metric and the second performance metric, generating a first fitness metric for the genetic algorithm; generating a plurality of configurations of symbolic syntax and a plurality of fitness metrics, each configuration in the plurality of configurations corresponding to a fitness metric in the plurality of fitness metrics; and using the plurality of fitness metrics, selecting a configuration of symbolic syntax from the plurality of configurations of symbolic syntax to be the updated genetic algorithm.
11. The method of any one of the preceding embodiments, further comprising using the third rule set to generate a second language processing model, wherein the second language processing model outputs classifications for input text sequences.
12. The method of any one of the preceding embodiments, wherein the first rule set comprises an activation pattern comprising a chain-of-thought prompting technique for activating the language processing model.
13. One or more tangible, non-transitory, computer-readable media storing instructions that, when executed by a data processing apparatus, cause the data processing apparatus to perform operations comprising those of any of embodiments 1-12.
14. A system comprising one or more processors; and memory storing instructions that, when executed by the processors, cause the processors to effectuate operations comprising those of any of embodiments 1-12.
15. A system comprising means for performing any of embodiments 1-12.

What is claimed is:

1. A system for training a language processing model for a chatbot, comprising:
one or more processors; and
one or more non-transitory, computer-readable media comprising instructions that, when executed by the one or more processors, cause operations comprising:
receiving a first rule set to regulate training a language processing model, wherein the first rule set includes one or more activation patterns, and wherein the one or more activation patterns are associated with translation of input text sequences into output text sequences by the language processing model;
training the language processing model using a training dataset associated with the chatbot and the first rule set to produce an output text sequence, wherein the language processing model is trained with a first loss function that rewards the language processing model for adherence to the first rule set;
generating a first performance metric for the language processing model as a result of the training, wherein the first performance metric is based on the first loss function and a second loss function that rewards the language processing model for producing output text sequences in accordance with the training dataset;
iteratively repeating:
using a genetic algorithm, generating a second rule set based on the first rule set, wherein the genetic algorithm uses symbolic syntax to evolve an input rule set into an output rule set;
using a reinforcement learning algorithm and the second rule set, updating parameters of the language processing model to generate an updated language processing model, wherein the reinforcement learning algorithm evaluates parameters of the language processing model for adherence to the second rule set;
generating a second performance metric for the updated language processing model, wherein the second performance metric is based on the first loss function and the second loss function;
based on the first performance metric and the second performance metric, using the reinforcement learning algorithm to update the genetic algorithm, wherein the reinforcement learning algorithm evaluates a plurality of configurations of symbolic syntax for the genetic algorithm to optimize the first performance metric and the second performance metric; and
based on the second performance metric exceeding a threshold value, determining to stop the iterative repetition; and
using the updated language processing model to generate a set of text responses to a set of queries.

2. A method for training a language processing model for a chatbot, comprising:
receiving a first rule set to regulate training a language processing model, wherein the first rule set includes one or more activation patterns, and wherein the one or more activation patterns are associated with translation of input text sequences into output text sequences by the language processing model;
training the language processing model using a training dataset associated with the chatbot and the first rule set to produce an output text sequence, wherein the language processing model is trained with a first loss function that rewards the language processing model for adherence to the first rule set;
generating a first performance metric for the language processing model as a result of the training, wherein the first performance metric is based on the first loss function and a second loss function that rewards the language processing model for producing output text sequences in accordance with the training dataset;
using a genetic algorithm, generating a second rule set based on the first rule set, wherein the genetic algorithm uses symbolic syntax to evolve an input rule set into an output rule set;
using a reinforcement learning algorithm and the second rule set, updating parameters of the language processing model to generate an updated language processing model, wherein the reinforcement learning algorithm evaluates parameters of the language processing model for adherence to the second rule set;
generating a second performance metric for the updated language processing model, wherein the second performance metric is based on the first loss function and the second loss function;
based on the first performance metric and the second performance metric, using the reinforcement learning algorithm to generate an updated genetic algorithm, wherein the reinforcement learning algorithm evaluates a plurality of configurations of symbolic syntax for the genetic algorithm to optimize the first performance metric and the second performance metric;
using the updated genetic algorithm, generating a third rule set based on the second rule set;
using the reinforcement learning algorithm and the third rule set to generate a final language processing model based on the updated language processing model; and
using the final language processing model to generate a set of text responses to a set of queries.

3. The method of claim 2, wherein the first rule set comprises an activation pattern comprising a chain-of-thought prompting technique for activating the language processing model.

4. The method of claim 2, wherein the first rule set comprises an activation pattern comprising a relationship between input text sequences and output text sequences for the language processing model.

5. The method of claim 2, wherein the first rule set comprises an activation pattern comprising a maximum depth, a maximum breadth, and an activation function for a deep neural network in the language processing model.

6. The method of claim 2, wherein the first rule set uses symbolic syntax to relate one or more activation patterns in logical succession.

7. The method of claim 2, wherein generating the second rule set using the genetic algorithm comprises:
using an evaluative function of the genetic algorithm, generating a fitness metric based on the first performance metric, wherein the fitness metric is a real-valued vector symbolizing a suitability of the first rule set for the language processing model;
generating a candidate rule set from the first rule set, wherein the candidate rule set comprises one or more activation patterns in the first rule set with values in the fitness metric above a threshold value; and
performing mathematical permutations on the candidate rule set to generate the second rule set, wherein the mathematical permutations modify values specifying activation patterns in the candidate rule set.

8. The method of claim 2, wherein generating the first performance metric for the language processing model as a result of the training comprises:
after training the language processing model, retrieving a set of runtime activation patterns, an input sequence set, and an output sequence set;
comparing the set of runtime activation patterns against the first rule set to generate an adherence score;
comparing the input sequence set and the output sequence set against a benchmark dataset to generate a correctness score, wherein the training dataset specifies example output sequence sets for each input sequence set; and
generating the first performance metric based on the adherence score and the correctness score.

9. The method of claim 2, wherein using a reinforcement learning regimen and the second rule set to update parameters of the language processing model comprises:
generating a second performance metric for the language processing model based on the second rule set;
using a gradient descent technique, generating a corrective vector based on the second performance metric, the corrective vector specifying numeric changes to parameter values of the language processing model; and
based on the corrective vector, updating parameter values of the language processing model.

10. The method of claim 2, wherein using the reinforcement learning algorithm to update the genetic algorithm based on the first performance metric and the second performance metric comprises:
based on the language processing model, the first performance metric and the second performance metric, generating a first fitness metric for the genetic algorithm;
generating a plurality of configurations of symbolic syntax and a plurality of fitness metrics, each configuration in the plurality of configurations corresponding to a fitness metric in the plurality of fitness metrics; and
using the plurality of fitness metrics, selecting a configuration of symbolic syntax from the plurality of configurations of symbolic syntax to be the updated genetic algorithm.

11. The method of claim 2, further comprising using the third rule set to generate a second language processing model, wherein the second language processing model outputs classifications for input text sequences.

12. One or more non-transitory, computer-readable media comprising instructions that, when executed by one or more processors, cause operations comprising:
receiving a language processing model and a first rule set to regulate the language processing model;
generating a first performance metric for the language processing model based on a first loss function that rewards the language processing model for adherence to the first rule set;
using a genetic algorithm, generating a second rule set based on the first rule set;
using a reinforcement learning algorithm and the second rule set, updating parameters of the language processing model to generate an updated language processing model, wherein the reinforcement learning algorithm evaluates parameters of the language processing model for adherence to the second rule set;
generating a second performance metric for the updated language processing model, wherein the second performance metric is based on the first loss function;
based on the first performance metric and the second performance metric, using the reinforcement learning algorithm to generate an updated genetic algorithm;
using the updated genetic algorithm, generating a third rule set based on the second rule set;
using a reinforcement learning algorithm and the third rule set to generate a final language processing model based on the updated language processing model; and
using the final language processing model to generate a set of text responses to a set of queries.

13. The one or more non-transitory, computer-readable media of claim 12, wherein the first rule set comprises an activation pattern comprising a chain-of-thought prompting technique for activating the language processing model.

14. The one or more non-transitory, computer-readable media of claim 12, wherein the first rule set comprises an activation pattern comprising a relationship between input text sequences and output text sequences for the language processing model.

15. The one or more non-transitory, computer-readable media of claim 12, wherein the first rule set comprises an activation pattern comprising a maximum depth, a maximum breadth, and an activation function for a deep neural network in the language processing model.

16. The one or more non-transitory, computer-readable media of claim 12, wherein the first rule set uses symbolic syntax to relate one or more activation patterns in logical succession.

17. The one or more non-transitory, computer-readable media of claim 12, wherein generating the second rule set using the genetic algorithm comprises:
using an evaluative function of the genetic algorithm, generating a fitness metric based on the first performance metric, wherein the fitness metric is a real-valued vector symbolizing a suitability of the first rule set for the language processing model;
generating a candidate rule set from the first rule set, wherein the candidate rule set comprises one or more activation patterns in the first rule set with values in the fitness metric above a threshold value; and
performing mathematical permutations on the candidate rule set to generate the second rule set, wherein the mathematical permutations modify values specifying activation patterns in the candidate rule set.

18. The one or more non-transitory, computer-readable media of claim 12, wherein generating the first performance metric for the language processing model comprises:
after training the language processing model, retrieving a set of runtime activation patterns, an input sequence set, and an output sequence set;
comparing the set of runtime activation patterns against the first rule set to generate an adherence score;
comparing the input sequence set and the output sequence set against a benchmark dataset to generate a correctness score, wherein the training dataset specifies example output sequence sets for each input sequence set; and
generating the first performance metric based on the adherence score and the correctness score.

19. The one or more non-transitory, computer-readable media of claim 12, wherein using a reinforcement learning regimen and the second rule set to update parameters of the language processing model comprises:
generating a second performance metric for the language processing model based on the second rule set;
using a gradient descent technique, generating a corrective vector based on the second performance metric, the corrective vector specifying numeric changes to parameter values of the language processing model; and
based on the corrective vector, updating parameter values of the language processing model.

20. The one or more non-transitory, computer-readable media of claim 12, wherein using the reinforcement learning algorithm to update the genetic algorithm based on the first performance metric and the second performance metric comprises:
based on the language processing model, the first performance metric and the second performance metric, generating a first fitness metric for the genetic algorithm;
generating a plurality of configurations of symbolic syntax and a plurality of fitness metrics, each configuration in the plurality of configurations corresponding to a fitness metric in the plurality of fitness metrics; and
using the plurality of fitness metrics, selecting a configuration of symbolic syntax from the plurality of configurations of symbolic syntax to be the updated genetic algorithm.
